(19) United States
(12) Patent Application Publication
(10) Pub. No.: US 2005/0228884 A1
(43) Pub. Date: Oct. 13, 2005

(54) Resource management

(75) Inventor: Adam Stanley James Hawley, Surrey (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Caplin Systems Limited, London (GB)

(21) Appl. No.: 10/517,253

(22) PCT Filed: Jun. 10, 2002
(86) PCT No.: PCT/GB02/02648

§ 371 Date: Dec. 8, 2004

(51) Int. Cl. G06F 15/173

(52) U.S. Cl. 709/225

(57) ABSTRACT

A method of load balancing for establishing persistent connections over the Internet, in which a client connects to a server an receives a list of servers capable of providing a service, together with status information indicating which of the servers are available, the number of users currently being served by each server and a priority grouping to which each server belongs. Based on the list, the client makes a decision as to the server that is to provide the service.

### FIELD OF THE INVENTION

The present invention relates to a method of resource management, wherein the resource to be managed comprises a plurality of servers for providing a service to a client. In particular, the present invention relates to a method of load balancing in which the server to be used to provide the service to the client is selected by the client.

### BACKGROUND

There are several known methods of load balancing, a technique which aims to ensure that clients requesting a service over the Internet receive the service reliably, while the load on the servers providing the service is evenly spread, so that no single server is overburdened. Conventionally, a client provides a URL address to log on to a web server which is associated with a particular service required by the client, for example viewing a website. Typically, for websites needing to handle a large volume of traffic, the URL is mapped to a number of servers arranged as a cluster, also known as a server farm. The server cluster is required to deal with all of the users requesting the service without overloading individual servers.

Typical Internet transactions involve each user making numerous HTTP (hypertext transfer protocol) requests during a single Internet session. Each request opens a connection between client and server. After the request is satisfied, for example by the provision of a web page in HTML (hypertext mark-up language) format, the connection is terminated. A subsequent request from the client restarts the connection process, so that each request is independent and can be routed to the most appropriate server, for example based on the number of users being served by the server. In general terms, in the case of an HTTP based service, the servers providing the service are identical from the user's point of view. Therefore, a reliable service can be provided to each user by spreading the user requests among the available servers in some predetermined manner.

Known load balancing methods include the DNS round-robin algorithm, various software-based load balancing packages as well as switch-based applications.

However, in cases where it is important for a user to maintain a connection to a particular server, the above approaches are not suitable.

### SUMMARY OF THE INVENTION

According to the invention, there is provided a method of resource management, the resource comprising a plurality of servers, each of which is capable of providing a service to a client, the method comprising the steps of receiving a request for the service from the client; in response to said request, providing the client with information identifying each of the plurality of servers and selecting, at the client, one of the plurality of servers as the server to be used to provide the service to the client.

By permitting the client to select the server to be used, the client can achieve greater control over the load balancing process.

According to the invention there is further provided a client in a client/server system, comprising means for requesting a service from a server, means for receiving information in response to said request, said information identifying each of a plurality of servers which are configured to provide the service and means for selecting one of the plurality of servers as the server to be used to provide the service to the client.

According to the invention, there is also provided a server in a client/server system having a plurality of servers each configured to provide a service, comprising means for receiving a request for the service from a client and means for sending information to the client in response to said request, said information identifying each of the plurality of servers to the client.

The invention further provides a client/server system having a plurality of servers each configured to provide a service to a client, comprising means for communicating information between the servers so that each of the plurality of servers maintains information relating to all of the servers, means for receiving a request for the service from a client and means for sending server information to the client in response to said request, said server information identifying each of the plurality of servers to the client.

### BRIEF DESCRIPTION OF THE DRAWINGS

Embodiments of the invention will now be described, by way of example, with reference to the accompanying drawings, in which:

FIG. 1 illustrates an Internet connection scheme including a plurality of servers for providing a service to a client;

FIG. 2 is a schematic diagram illustrating how identity and status information is exchanged between servers;

FIG. 3 is a flow diagram illustrating the process of initial server selection; and

FIG. 4 is a flow diagram illustrating the process of server selection in the event that a connection fails.

### DETAILED DESCRIPTION

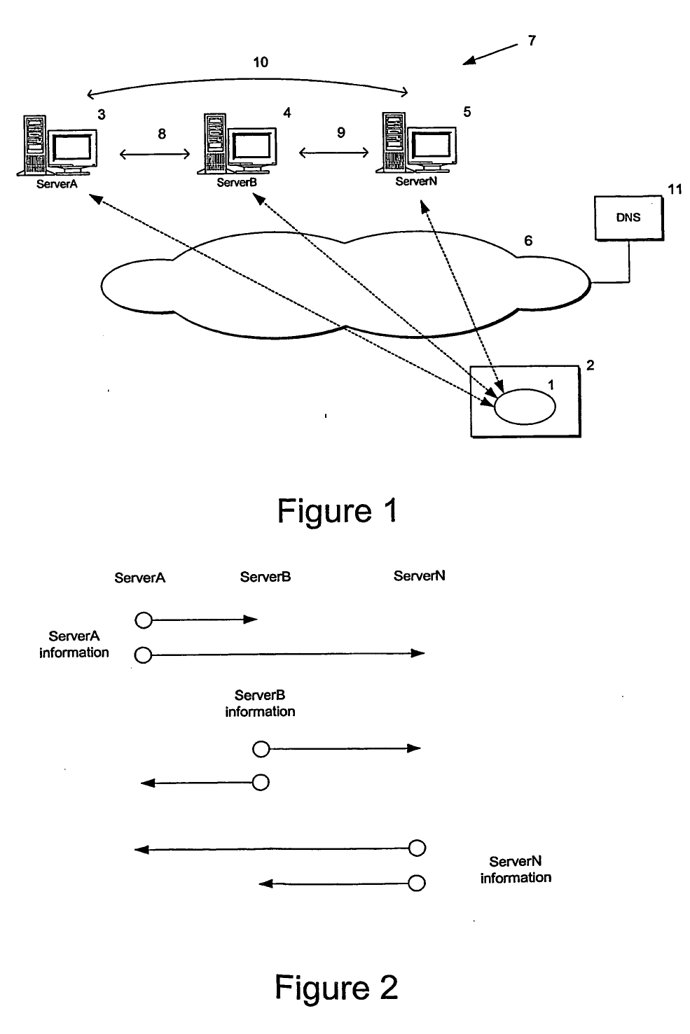

FIG. 1 illustrates a system on which the invention can be implemented in which a user uses browser software 1 running on a computer 2 to access any one of a number of server machines 3-5 via the Internet 6. The browser software 1, for example, Internet Explorer™ or Netscape Navigator™, is referred to herein as a client 1. The server machines 3-5, collectively referred to herein as a server farm 7, are configured to provide services, for example web pages, to the client 1. The server machines 3-5 are also referred to herein as data servers or simply servers.

Each of the plurality of server machines ServerA 3, ServerB 4 and ServerN 5 has a point to point connection 8-10 to each of the other servers in the farm 7.

It will be understood that each of the data servers 3-5 comprise conventional server computers which have the necessary hardware and operating system and application software to implement the functionality defined by the invention.

The domain name of each server 3-5 in the farm 7 maps to an Internet Protocol (IP) address, in a conventional way, making use of an Internet service known as the Domain Name Service or System (DNS) 11. For example, ServerA 3 with url http://serverA.caplin.com maps to IP address 1.1.1.1, ServerB 4 with url http://serverB.caplin.com maps to IP address 1.1.1.2 and ServerN 5 with url http://serverN.caplin.com maps to IP address 1.1.1.3. In addition a single service url maps to all of the servers in the farm 7. For example, url http://service.caplin.com maps to IP addresses 1.1.1.1, 1.1.1.2 and 1.1.1.3.

Referring to FIG. 2, the servers 3-5 communicate with one another via the point to point connections 8-10 and update one another in real-time on the number of users each has connected. Therefore, each server machine 3-5 is aware of the identity and status of all of the other server machines in the farm 7. The status information held by each of the server machines 3-5 includes information as to whether the machine is available, for example whether it is currently ‘UP’, or ‘DOWN’, for example for maintenance. Each server machine 3-5 can, for example, set another server machine's status as DOWN if it fails to receive a status report when expected or following a simple negotiation to establish if the machine is available. In general terms, each server machine holds the following four pieces of information about each of the available server machines:
1. Domain Name
2. Status
3. Number of Connected Users
4. Priority

The PRIORITY field is used to allow the server farm 7 to consist of primary and secondary servers. For example, primary servers might be on a high bandwidth network and secondary servers on a low bandwidth one. The client 1 would try and connect first to the highest priority servers and only try the next priority down if no highest ones were available. This can be used for 2 or more levels of priority.

In the example given above, the information held by each server for servers 3-5 is:
http://serverA.caplin.com UP 2963 A
http://serverB.caplin.com DOWN 0 B
http://serverN.caplin.com UP 2979 A

The information indicates that ServerA and ServerN are available (status=UP) and are currently serving 2963 and 2979 users respectively, while ServerB is not currently available (status=DOWN). ServerA and ServerN both have the highest level of priority (A) while ServerB has the next level down (B).

A method of load balancing across the server farm 7 will now be described in detail.

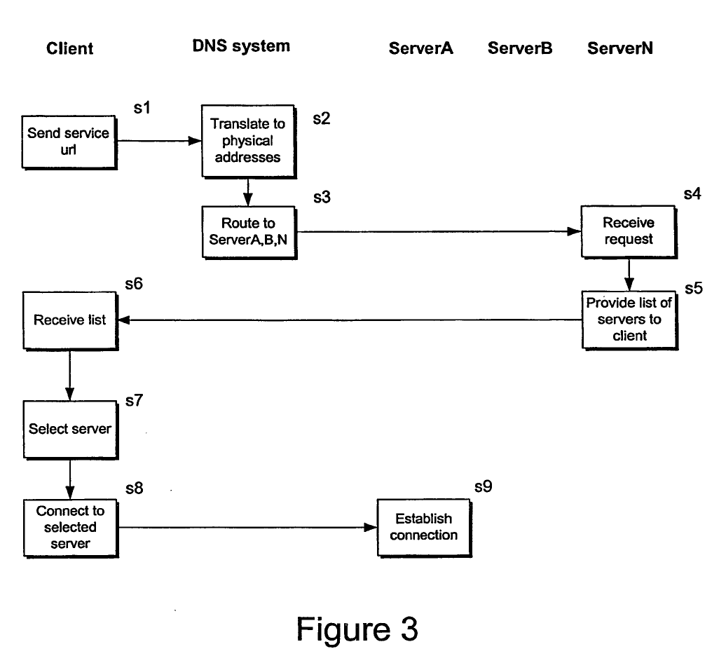

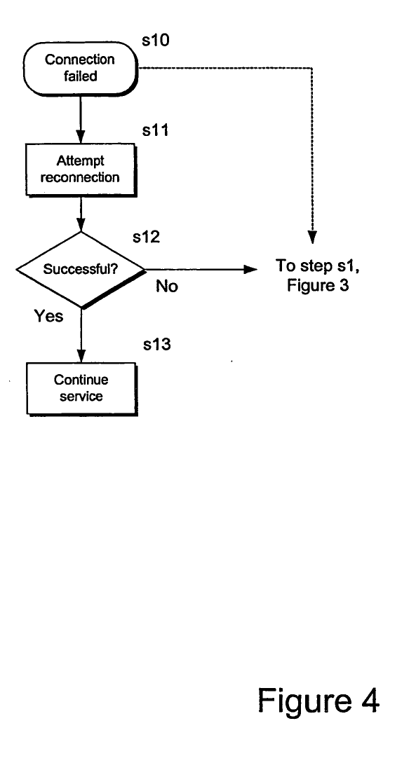

Referring to FIGS. 1 and 3, the client 1 requests a service by entering the service url, for example service.caplin.com, at his browser (step s1). The request is sent through the Internet to the DNS system 11 for translation of the service url into a physical IP address. The DNS system 11 determines that the service url translates into N physical IP addresses (step s2). It therefore applies a round-robin algorithm, local direction or other conventional technique to route the client request to one of the plurality of data servers ServerA 3, ServerB 4 and ServerN 5 (step s3). For example, the round robin DNS technique selects a first one of the N physical IP addresses, connects the user to this address and sends the selected address to the back of the list, so that a subsequent request to the DNS system 11 will be directed to a second different one of the IP addresses.

In this example, the service being provided is a real-time data streaming service and each of the servers 3-5 is a push data server implementing the RTTP (Real-Time Transfer Protocol) server-push protocol developed by Caplin Systems Ltd. To implement the data streaming service, a persistent connection, also known as a ‘sticky’ connection, is required. A connection is opened between the client and a selected server but is not closed once a response has been received from the server. Instead, the connection is maintained so that the server can send down real-time streaming data on a continuous basis, without the overhead of opening and closing the connection each time. In this case, it is therefore important that the client 1 maintains a connection with a given server for as long as possible.

For the purpose of this example, it is assumed that the client request is routed to and received by the data server ServerN 5 (step s4). As described above with reference to FIGS. 1 and 2, each of the data servers 3-5 maintain a list of all of the data servers 3-5 which are capable of providing the service to the client 1. Data server ServerN 5, which therefore acts as a list server in this example, sends the list to the client 1 (step s5). The list may be in text, Javascript™, XML format or any other format which is appropriate for the particular client. The client 1 receives the list (step s6) and selects the data server from which it wishes to receive the service (step s7), based on the status and priority information for each of the data servers 3-5 in the list and its own predetermined rules. For example, the data server to be used is selected at random from data servers which have status ‘UP’ within a given priority group, with a weighting which depends on the number of connected users. For instance, each server 3-5 is associated with a probability of being chosen of:

$$\frac{\begin{matrix}1 - ( No . of connected users for selected server / \\ Total number of connected users )\end{matrix}}{Number of live servers - 1} .$$

Therefore, for the example figures given above, the probabilities of being chosen associated with ServerA 3 is 0.501, while that for ServerC 5 is 0.499. So ServerA 3 would, in this instance, be more likely to be chosen for further communication.

Assuming ServerA 3 is chosen, the client 1 then attempts to establish a connection with ServerA 3 (steps s8, s9).

Referring to FIG. 4, in the event that a connection cannot be established, or a connection that has been established subsequently fails (step s10), the client 1 attempts to reconnect to the same server (step s11). If the reconnection attempt proves successful (step s12), then the service continues as before (step s13). If it proves unsuccessful (step s12), then the client 1 re-requests the service information (step s1) to obtain a fresh list of available servers, since the status of many of the servers is likely to have changed since the last download.

In an alternative embodiment, failure to connect to a selected server (step s10) leads to an immediate re-request of the service information (step s1), as indicated by the dotted line in the Figure.

It will be understood by the skilled person that the embodiments described above are illustrations of the invention only and many modifications and variations are possible within the scope of the claims.

1. A method of providing a service to a client from one of a plurality of servers, each of the servers being capable of providing the service to the client and each of the servers being associated with a service address common to all of the servers, the method comprising the steps of
receiving a request for the service from the client, the request specifying the common service address;
in response to the request, connecting the client to one of the plurality of servers;
receiving, at the client, information identifying each of the plurality of servers from the server to which the client is connected; and
selecting, at the client, one of the plurality of servers as the server to be used to provide the service to the client.

2. A method according to claim 1, including the step of providing the client with information relating to the status of each of the plurality of servers.

3. A method according to claim 1 or 2, including the step of providing the client with information relating to the number of users being served by each of the plurality of servers.

4. A method according to claim 3, wherein the step of selecting a server includes selecting the server in dependence on the number of users being served by each of the plurality of servers.

5. A method according to any one of the preceding claims, including the step of providing the client with information relating to a grouping to which each of the plurality of servers belong.

6. A method according to claim 5, including selecting the server in dependence on the grouping.

7. A method according to any one of the preceding claims, wherein the step of selecting a server comprises randomly selecting a server.

8. A method according to any one of the preceding claims, including routing the client request to one of the plurality of server using a DNS round-robin algorithm.

9. A method according to any one of the preceding claims, wherein each of the plurality of servers holds information relating to all of the serves.

10. A method according to claim 9, including the step of communicating said information between the servers in real-time.

11. A method according to claim 9 or 10, wherein the information includes one or more of information identifying each of the servers, status information for each of the servers, information defining the number of users connected to each of the servers and grouping information for each of the servers.

12. A method according to any one of the preceding claims, further comprising requesting a connection to the selected server.

13. A method according to claim 12, including, in the event that the connection to the selected server fails, attempting to reconnect to the selected server.

14. A method according to claim 13, further comprising, in the event that the reconnection attempt fails, re-requesting the service to obtain the identifying information for servers configured to provide the service.

15. A client for use in a client-server system, comprising:
means for requesting a service, the request specifying a service address common to all of a plurality of servers, each of the plurality of servers being capable of providing the service to the client;
means operable to connect to one of the plurality of servers;
means operable to receive information from the server to which the client is connected, said information identifying each of the plurality of servers; and
means for selecting one of the plurality of servers as the server to be used to provide the service to the client.

16. A client according to claim 15, wherein the information identifying each of the plurality of serves further includes information relating to the status of each of the plurality of servers.

17. A client according to claim 15 or 16, wherein the information identifying each of the plurality of servers further includes information relating to the number of users be serviced by each of the plurality of severs.

18. A client according to claim 15, 16 or 17, wherein the information identifying each of the plurality of servers further includes information relating to a grouping to which each of the plurality of servers belongs.

19. A client according to any one of claims 15 to 18, wherein the selecting means is arranged to randomly select one of the plurality of servers.

20. A client according to any one of claims 15 to 19, wherein the selecting means is arranged to select one of the plurality of servers in dependence on one or more of the number of users being serviced by each of the plurality of servers, the status of each of the servers and the grouping to which each of the servers belongs.

21. A server for use in a client-server system having a plurality of servers, each of the servers being capable of providing a service to the client and each of the servers being associated with a service address common to all of the servers, the server comprising:
means configured to receive information relating to each of the plurality of servers;
means configured to connect to the client in response to a request from the client for the service, the request specifying the common service address;
means configured to send information to the client, the information identifying each of the plurality of servers to the client; and
means configured to connect to the client in response to a selection, at the client, of one of the plurality of servers as the server to be used to provide the service to the client.

22. A server according to claim 21, comprising a Real-Time Text Protocol server.

23. A client-server system having a plurality of servers, each of the servers being capable of providing the service to the client and each of the servers being associated with a service address common to all of the servers, the system comprising:
means for communicating information between the servers so that each of the plurality of severs maintains information relating to all of the servers;
means for receiving a request for the service from the client, the request specifying the common service address;
means configured to connect the client to one of the plurality of servers in response to the request;
means for sending server information to the client from the server to which the client is connected, said server information identifying each of the plurality of servers to the client; and
means for selecting, at the client, one of the plurality of servers as the server to be used to provide the service to the client.

24. A system according to claim 23, wherein the server information further includes information relating to the status of each of the plurality of servers.

25. A system according to claim 23 or 24, wherein the server information further includes information relating to the number of users connected to each of the plurality of servers.

26. A system according to any one of claims 23 to 25, wherein the servers comprise RTTP servers.

27. A system according to say one of claim 23 to 26, wherein the servers are operable to communicate in real-time.
